(19) United States
(12) Patent Application Publication
(10) Pub. No.: US 2004/0206025 A1
(43) Pub. Date: Oct. 21, 2004

(54) Casing, door or window frame, particularly for outdoor use

(75) Inventor: Giorgio Panto, Treviso (IT)

Correspondence Address: MODIANO & ASSOCIATI, Via Meravigli, 16, MILANO, 20123, IT

(73) Assignee: PANTO S.P.A.

(21) Appl. No.: 10/821,977

(22) Filed: Apr. 12, 2004

(30) Foreign Application Priority Data
Apr. 15, 2003 (IT) PD2003A000073
Jul. 17, 2003 (IT) PD2003U000061

(51) Int. Cl. E06B 1/04

(52) U.S. Cl. 52/211; 52/302.1

(57) ABSTRACT

A frame for casings, doors or windows and the like, particularly but not exclusively for outdoor use, applicable to casings and corresponding sashes of windows, doors, front doors, sliding sashes, center-hung sashes, matchboard shutters, Venetian-style shutters, open/closed slat shutters. The frame has a base framework of one or more laminated wood layers, an exposed finishing veneer adhered to the inside side and a metal skin for facing and protection, adhered to the framework; the metallic skin provides a frame with aesthetic finish and weather protection.

The present invention relates to a frame for casings, doors or windows and the like, particularly but not exclusively for outdoor use.

In particular, the present invention can be applied to casings and to the corresponding sashes of windows, doors, doors with door frame, entrance doors, sliding doors or windows, center-hung sashes, shutters of various types such as matchboard shutters, Venetian-style shutters, open/closed slat shutters, et cetera.

### BACKGROUND OF THE INVENTION

Currently, the door and window market is becoming orientated toward the choice of component materials that achieve high performance in terms of durability without having to perform any maintenance.

Particular attention is paid to the materials that compose doors or windows and corresponding casings for outdoor use.

These are in fact most affected by early aging, both because they are exposed to the effects of weather and because of the chemical attacks caused by pollution.

Casings are formed by a frame that can be fixed to the jambs of the openings to be closed and is provided with an inward side and an outward side with respect to the building in which the frame is applied.

Likewise, the corresponding doors or windows are also formed by a frame, which can be fixed to the casing and is provided with an inward side and an outward side.

The outward sides of the frames are the ones exposed to the effects of weather and to the highest concentration of pollutants and therefore are the ones that deteriorate more rapidly.

The most widespread type of door or window and casing is substantially based on a structure that is entirely made of wood.

Wood deteriorates rapidly and periodically needs maintenance, including stripping and repainting, especially on the outward side of the frame.

In order to obviate these drawbacks, frames made of metallic material such as aluminum are currently known and used.

However, these aluminum frames have a distinctly higher production cost than equivalent wood frames, due both to the structural complexity of the profiled elements that form them and to the particular operations for assembling their components.

Moreover, their users often perceive them negatively, since they are considered cold and unaesthetic.

### SUMMARY OF THE INVENTION

The aim of the present invention is to provide a frame for casings, doors or windows and the like, particularly for outdoor use, that solves the drawbacks noted above in known types.

Within this aim, an object of the present invention is to provide a frame for casings, doors or windows and the like, particularly for outdoor use, that withstands the deterioration caused by the atmospheric environment and by pollutants and has low production costs.

Another object of the present invention is to provide a frame for casings, doors or windows and the like, particularly for outdoor use, that has a high-value finish.

Another object of the present invention is to provide a frame for casings, doors or windows and the like, particularly for outdoor use, that is strong and stable from a geometric and structural standpoint.

Another object of the present invention is to provide a frame for casings, doors or windows and the like, particularly for outdoor use, that can be manufactured with known systems and technologies.

This aim and these and other objects that will become better apparent hereinafter are achieved by a frame for casings, doors or windows and the like, particularly for outdoor use, comprising a base framework constituted by at least one laminated wood layer, characterized in that it comprises a metal skin for facing and outward protection and means for the adhesion of said skin to said framework.

### BRIEF DESCRIPTION OF THE DRAWINGS

Further characteristics and advantages of the present invention will become better apparent from the following detailed description of a preferred but not exclusive embodiment thereof, illustrated by way of non-limiting example in the accompanying drawings, wherein:

FIG. 1 is a sectional axonometric view, taken along a transverse plane, of the lower cross-members of a pair of frames according to the invention, respectively of a window sash and of a window casing;

FIG. 2 is a sectional axonometric view, taken along a transverse plane, of the lateral posts of a pair of frames according to the invention, respectively of a window sash and of a window casing;

FIG. 3 is a sectional axonometric view, taken along a transverse plane, of a portion of the lower cross-members of a pair of frames, in a second embodiment according to the invention, respectively of a window sash and of a window casing;

FIG. 4 is a sectional axonometric view, taken along a transverse plane, of a portion of the lateral posts of a pair of frames, in a second embodiment according to the invention, respectively of a window sash and of a window casing;

FIG. 5 is a cutout axonometric view of a frame of a vertical matchboard shutter according to the invention;

FIG. 6 is a front view of a frame of a slat shutter according to the invention;

FIG. 7 is a sectional side view of a portion of the slat shutter frame of FIG. 6;

FIG. 8 is a sectional perspective view, taken along a transverse plane, of a perimetric portion of another embodiment of the frame according to the invention.

### DESCRIPTION OF THE PREFERRED EMBODIMENTS

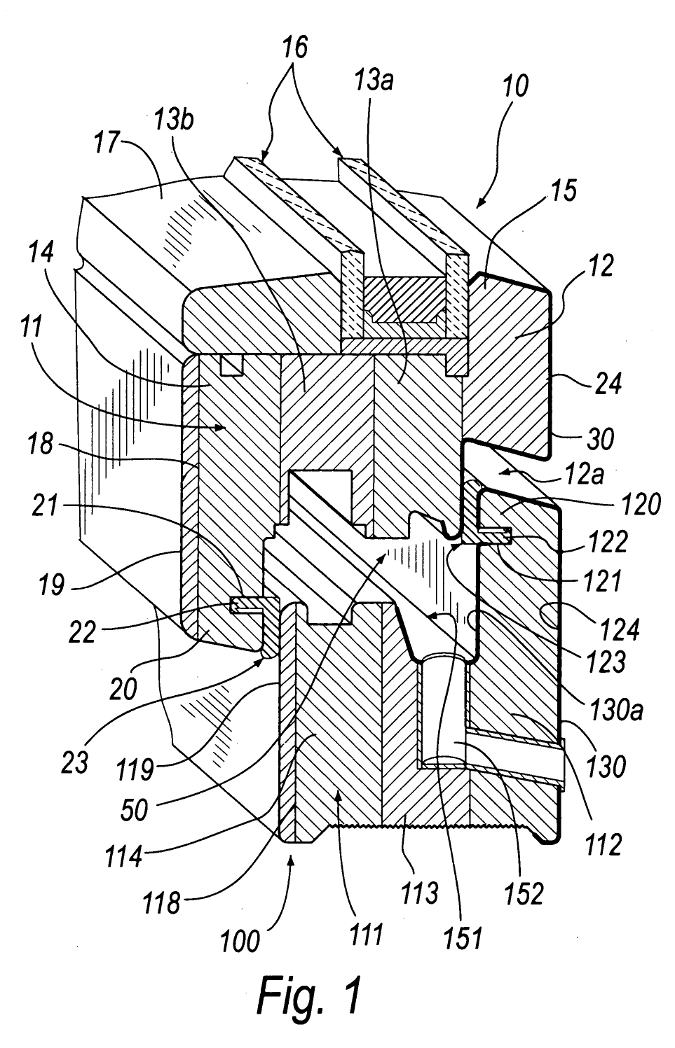

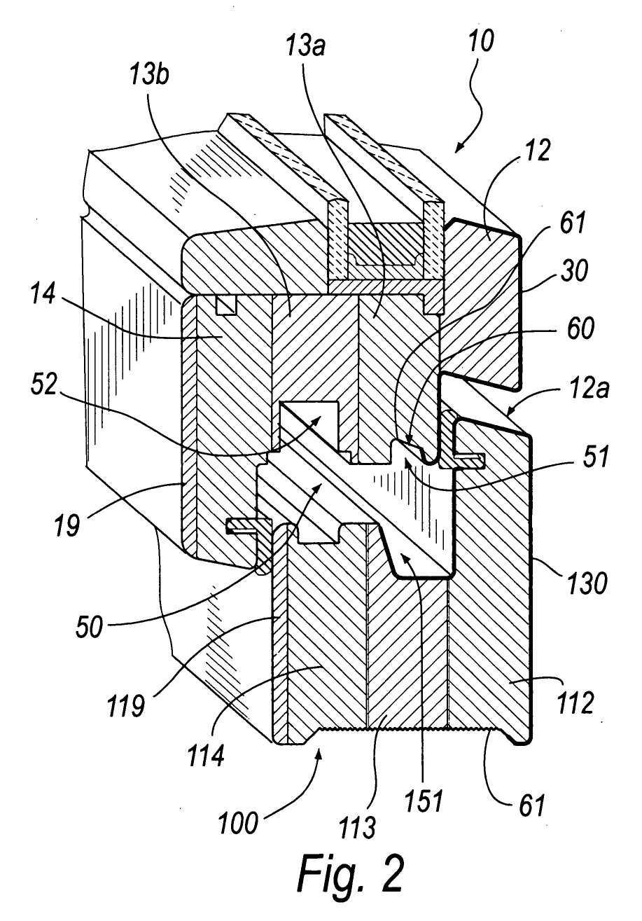

With reference to FIGS. 1 to 4, a first frame related to a window sash, according to the invention, is generally designated by the reference numeral 10.

Likewise, a second frame of a complementary casing, according to the invention, is generally designated by the reference numeral 100.

The first sash frame 10 and the second casing frame 100 are substantially composed of the same components; for the sake of simplicity, therefore, the first sash frame 10 will be described mostly hereinafter.

When the complementary components of the second frame 100 are described, they will be designated by the same name as the first frame 10 but with progressive, generally corresponding, numerals increased by one hundred.

The first sash frame 10 comprises a perimetric base framework 11 that is constituted in this case by four laminated wood layers that are mutually bonded by gluing: respectively, an outward layer 12, two central layers 13a and 13b, and an inward layer 14.

The outward layer 12 protrudes, parallel to the plane of the window, with a portion 15 with respect to the other three layers 13a, 13b and 14, and acts as an abutment for a double-glazing unit 16.

The double-glazing unit 16 is sandwiched between the portion 15 and a rim 17 that is fixed to the inward layer 14.

An exposed finishing veneer 19, made of high-value wood (for example oak, chestnut, birch, rift-sawn fir, larch or mahogany, et cetera) or very high-value wood (for example teak, rosewood, et cetera), is applied to the side of the framework 11 that is directed toward the inside of the building to which the frame 10 is applied, in practice on the inward face 18 of the inward layer 14.

The thickness of said veneer can be for example 3-4 mm, and the veneer is cold- or high frequency-bonded and pressed.

The inward layer 14 protrudes toward the second frame 100 of the casing in the opposite direction with respect to the protrusion of the portion 15 of the outward layer 12 with a part 20 with respect to the other two layers 13 and 14.

The protruding part 20 acts as an internal closure element of the window, abutting against the inward side of the second frame 100 (in particular against the exposed finishing veneer 119 of the inward layer 114).

A slot 21 is provided on the protruding part 20 of the inward layer 14 of the sash frame 10 and accommodates a fixing portion 22 of a first L-shaped gasket 23 that is interposed between the frames 10 and 100 when the window is closed.

A metallic facing skin 30 is made to adhere, by way of adhesion means specified hereinafter, to the side of the framework 11 that is directed toward the outside of the building to which the first frame 10 is applied, in practice on the entire visible outward face 24 of the outward layer 12.

The outward layer 12 forms an acute-angled recess 12a together with the adjacent central layer 13a, and the metallic facing skin 30 also adheres to the portion of the central layer 13a that is formed by the recess 12a.

The metallic skin 30 has, for example, a thickness comprised between 0.1 mm and 0.35 mm and is preferably made of aluminum alloy, for example alloy types 3005 or 8011, in one of the following physical states: H14, H16, H34.

As an alternative, the metallic skin 30 can be made of materials or alloys such as copper, brass, bronze, steel, et cetera.

In the case of brass and copper, these materials are in the soft or annealed physical state.

The metallic skin 30 has an external finish provided by means of a heat-sealing lacquer.

The means for the adhesion of the metallic skin 30 to the outward layer 12 comprise, for example, an adhesive of the reactive hot-melt type based on polyurethane with post-crosslinking.

As an alternative, said adhesion means can comprise a thermal bonding film that is interposed between the metallic facing skin 30 and the outward layer 12.

Consider now the second casing frame 100; the materials of the corresponding components of the first sash frame 10 and of the second casing frame 100 are substantially the same.

The base framework 111 of the second frame 100 is composed of an outward laminated layer 112, a central laminated layer 113, and an inward laminated layer 114, which are respectively bonded to each other by means of adhesive.

An exposed finishing veneer 119, made of valuable or highly valuable wood, adheres to the inward face 118 of the inward layer 114.

A metallic finishing skin 130 adheres to the entire exposed outward face 124 of the outward layer 112.

In particular, the outward layer 112 protrudes in the opposite direction with respect to the protrusion of the part 20 of the first frame 10 that abuts against the veneer 119 with a portion 120 with respect to the other two layers 113 and 114.

The portion 120 of the outward layer 112 acts as an abutment for the outward side of the first frame 10 when the window is closed.

A slot 121 is provided on the portion 120 of the outward layer 112 of the first frame 10 and accommodates a portion 122 for fixing a second L-shaped gasket 123 that is interposed between the frames 10 and 100 when the window is closed.

With reference to FIG. 1, which is a sectional view of the lower cross-members of the first sash frame 10 and of the second casing frame 100 of a window, the outward layer 12 surmounts, when the window is closed, the region occupied by the second gasket 123, so as to protect the outer closure region of the window against the rain, like a shelter, thus reducing possible infiltrations of water between the first frame 10 and the second frame 100.

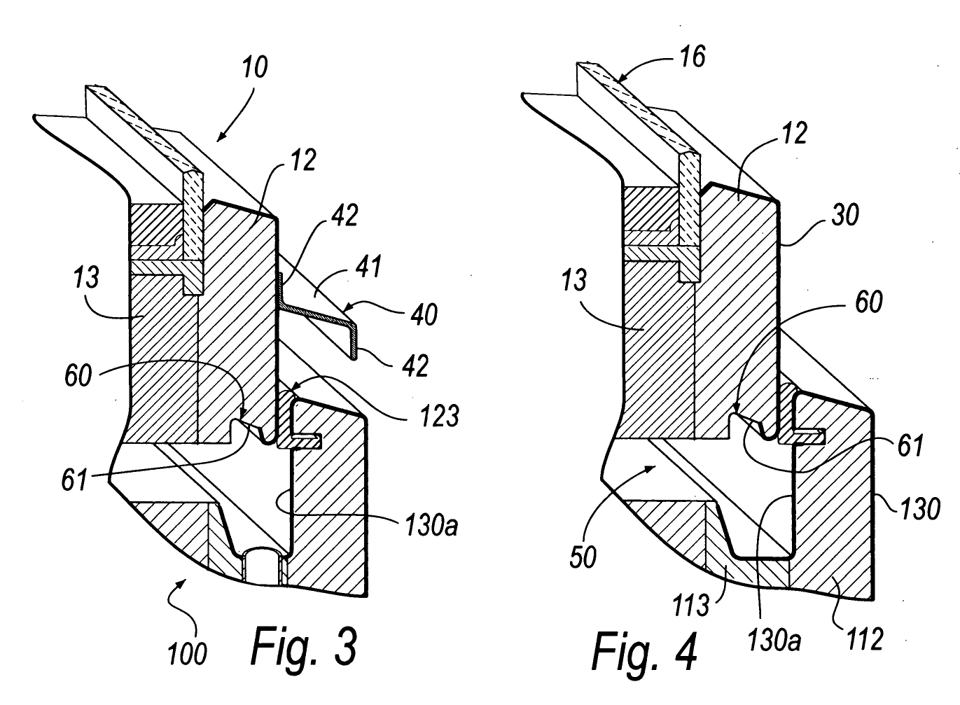

With reference to FIGS. 3 and 4, an alternative embodiment of the invention comprises a base framework 11 of the first sash frame 10 that is provided by means of only three laminated layers; the outward layer 12, the central layer 13, and the inward layer 14.

With reference to FIG. 3, which is a sectional view of a portion of the lower cross-members of the first sash frame 10 and of the casing frame 100 of a window, a metallic profiled element 40 is fixed to the metallic skin 30 of the first frame 10 and is constituted by a central plate 41, which is inclined toward the lower part of the window (and therefore toward the second frame 100), and by two parallel wings 42, which protrude on opposite sides with respect to the plate 41.

The metallic profiled element 40 is fixed by means of one of said wings 42 and surmounts, when the window is closed, the region occupied by the second gasket 123, so as to protect against the rain, like a shelter, the outward closure region of the window, thus reducing possible infiltrations of water between the first frame 10 and the second frame 100.

With reference again to both embodiments, when the window is closed, a gap 50 is formed between the first frame 10 and the second frame 100.

In particular, the second casing frame 100 has a groove 151 that is formed at the base of the protruding portion 120 of the outward layer 112.

The groove 151 is covered on its sides by a portion of metallic film 130a that is similar to the metallic skin 130 that adheres to the visible outward face 124.

With reference to the lower cross-member of the window (and therefore to FIGS. 1 and 3), the groove 151 corresponds to a channel for accumulating condensation and has a channel 152 for discharging externally said condensation that passes within the laminated layers.

Within the gap 50, the frame 10 has a first longitudinal recess 51, which is formed proximate to the coupling of the metallic skin 30, and a second longitudinal recess 52, which is larger than said first recess 51 and is formed centrally between the laminated layers.

The sash frame 10 and the casing frame 100 further comprise means 60 for ventilating the wood portion of said framework proximate to said metallic skin; said means are constituted for example by regions 61 that are not covered by the metallic skin 30 and are adjacent to the peripheral end portion of said metallic skin.

The ventilation means 60 can also comprise a plurality of microperforations, not shown in the figures, provided in series on the metallic skin 30; the dimensions of said microperforations are such that water finds it difficult to enter them but are sufficient to ventilate the underlying wood.

In particular, said microperforations are used for shutters or doors or otherwise for casings with extensive wood surfaces, which accordingly have central parts that are difficult to ventilate from the peripheral region.

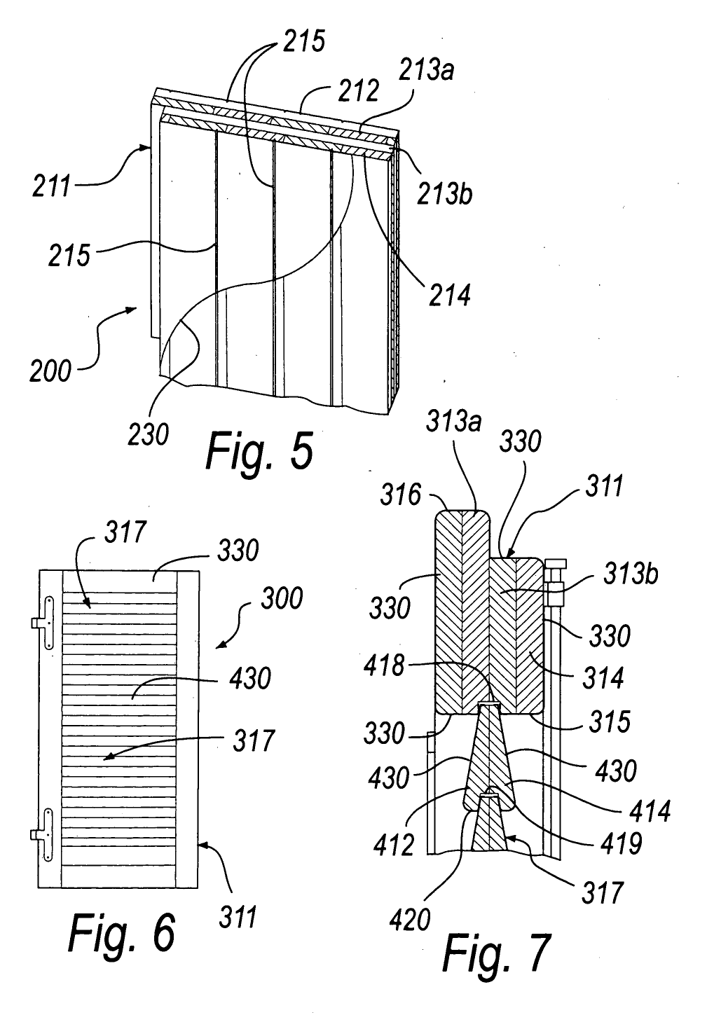

With reference to FIG. 5, an embodiment of the invention is designated by the reference numeral 200 and corresponds to a frame of a matchboard shutter.

As before, said shutter frame 200 comprises a base framework 211, which is constituted for example by four laminated wood layers that are mutually bonded by gluing: respectively, an outward layer 212, two central layers 213a and 213b, and an inward layer 214.

The metallic facing skin 230 adheres both to the outward layer 212 and to the inward layer 214.

Both the outward layer 212 and the inward layer 214 have vertical grooves 215 that the skin 230 follows completely.

With reference to FIGS. 6 and 7, another embodiment of the invention is designated by the reference numeral 300 and corresponds to a slat shutter frame.

As described earlier, said slat shutter frame 300 comprises a perimetric base framework 311, which is constituted for example by four laminated wood layers that are mutually bonded by gluing: respectively, an outward layer 312, two central layers 313a and 313b, and an inward layer 314.

The metallic facing skin 330 adheres to the outward layer 312, to the inward layer 314, to the inward and outward edge portions 315 and 316 of the base framework 311.

The slats 317, provided in an inward layer 414 and an outward layer 412 that are mutually bonded by adhesive, also have a metallic facing skin 430 that adheres directly to their entire surface, both on the outward layer 412 and on the inward layer 414.

In particular, on each slat 317 the skin 430 is provided in two parts that are respectively fixed to the outward layer 412 and to the inward layer 414 and end by folding onto the head 418 of the slat and inside the groove 419 formed on the bottom 420 of said slat.

The groove 419 is suitable for coupling to the head of a corresponding contiguous slat.

Alternative embodiments of the invention relate to frames for doors, front doors, et cetera, and respective door frames, are substantially similar to the preceding ones and are characterized in that they comprise said metallic facing skin for outward protection of said means for the adhesion of said skin to said framework.

For example, the frame of a door (not shown in the figures) comprises a base framework that is composed of a plurality of laminated layers that are respectively mutually bonded by adhesive.

An exposed finishing veneer, made of valuable or extremely valuable wood, is made to adhere to the face of the inward layer.

Said metallic facing skin is applied by adhesion to the entire visible outward surface of the door.

Optionally, said metallic skin may adhere to both faces of the door.

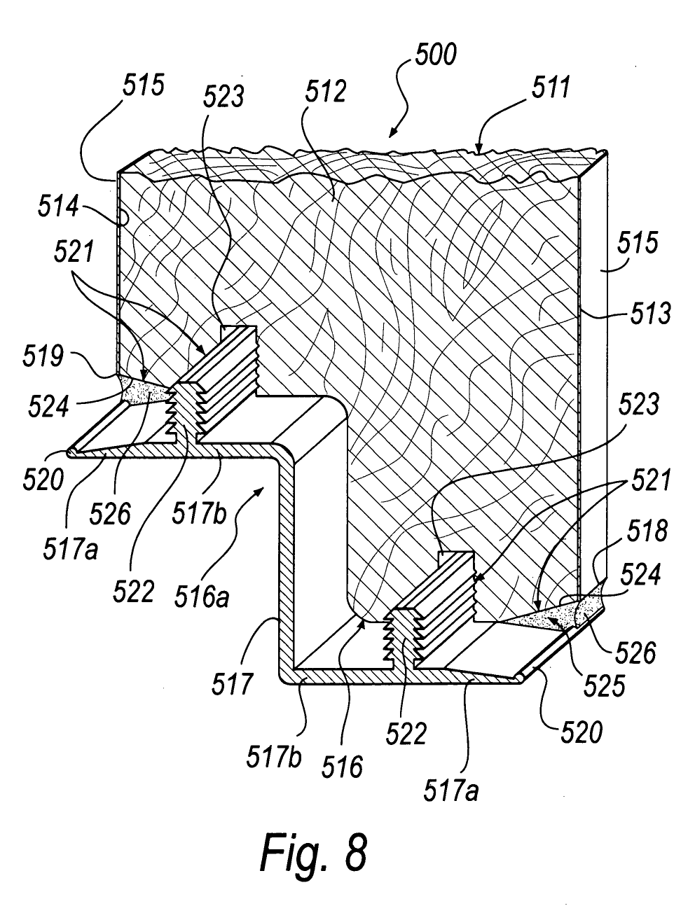

With reference to FIG. 8, a frame according to the invention is generally designated by the reference numeral 500.

In this embodiment, said frame relates to a shutter, for example of the matchboard type.

The frame 500 comprises a base framework 511, which is constituted in this embodiment by a single laminated wood layer 112; as an alternative, said framework may be constituted by a plurality of wood layers.

A metallic facing skin 515 for outward protection adheres to the base framework 511 on the side 513 of the framework 511 that is directed toward the outside of the building to which the frame is applied (with reference to the case of a closed casing on the building) and on the corresponding inward side 514.

The metallic skin 515 has, for example, a thickness comprised between 0.1 mm and 0.35 mm and is preferably made of aluminum alloy, for example alloy types 3005 or 8011, in one of the following physical states: H14, H16, H34.

As an alternative, the metallic skin 515 can be made of copper, brass, bronze, steel, et cetera and can have an external finish provided by means of a thermal bonding lacquer.

In order to make the metallic skin 515 adhere to the wood layer 512, it is possible to use for example an adhesive of the reactive hot-melt type based on polyurethane with post-crosslinking; as an alternative, it is possible to interpose a thermal bonding film.

In this embodiment, the perimetric edge 516 of the base framework 511, delimited on the outer side 513 and on the inner side 514 (except for the portion related to the hinges of the sash) is formed by a step-like portion 516a for abutment during closure of the sash onto a corresponding casing portion (not shown).

A metallic protective lamina 517 is fixed along the step-like portion 516a and substantially duplicates its step-like configuration.

In particular, in this embodiment the metallic lamina 517 is an extruded aluminum profile.

At the outer edge 518 and at the inner edge 519 of the framework 511, the metallic lamina 517 has a region 517a that gradually decreases in thickness until it ends with a wider rim 520 that has a substantially circular transverse cross-section.

The metallic lamina 517 is coupled to the perimetric edge 516 by way of fixing means 521, constituted by two longitudinal tabs 522 that each protrude at right angles from a respective one of the two parallel surfaces 517b of the metallic lamina 517 that duplicate the step-like portion 516a.

The tabs 522 are inserted within corresponding slots 523 formed in the layer 512.

In particular, the longitudinal tabs 522 are sawtooth-shaped on opposite sides and are inserted with interference in the slots 523, which have a rectangular cross-section.

Advantageously, the fixing means 521 comprise silicone 526 (or an equivalent material having the same waterproofing and adhesiveness characteristics), which is arranged between the lamina 517 and the layer 512, as described hereinafter.

At the outer edge 518 and at the inner edge 519, the framework 511 has a bevel 524.

The bevel 524 and the thinner region 517a of the lamina 517 form a cavity 525 for retaining the silicone 526.

The metallic skin that adheres to the outward and inward sides of the framework allows to protect the wood against the effects of weather acting directly on said sides.

In practice it has been found that the invention thus described solves the problems noted in known types of frame for casings, doors or windows and the like, particularly for outdoor use; in particular, the present invention provides a frame for casings, doors or windows and the like, particularly for outdoor use, that withstands deterioration caused by the atmospheric environment and by polluting agents.

The metallic skin that adheres to the outward side of the frame in fact allows to protect the wood from the effects of weather and requires no maintenance.

Moreover, the present invention provides a frame for casings, doors or windows and the like, particularly for outdoor use, that has a high-value finish.

The use of an exposed finishing veneer of high-value wood on the inward side of the frame in fact makes the casing and the door or window aesthetically appreciable.

The possibility to apply lacquer to the metallic skin further allows to obtain a luxury finish with an extremely vast color range.

Moreover, it should be noted that the ventilation means spare the wood from rotting due to humidity, since the metallic skin tends to not allow paths for the escape of moisture particles.

The metallic lamina that is fixed to the perimetric edges of the framework also allows indirect protection of the door or window, avoiding for example contact with the rain that infiltrates between the door or window and the casing when the door is closed.

The fixing of the metallic lamina to the perimetric edges of the framework provides an optimum seal and is easy and quick to perform.

The invention thus conceived is susceptible of numerous modifications and variations, all of which are within the scope of the appended claims; all the details may further be replaced with other technically equivalent elements.

In practice, the materials employed, so long as they are compatible with the specific use, as well as the dimensions, may be any according to requirements and to the state of the art.

The disclosures in Italian Patent Application No. PD2003A000073 and in Italian Utility Model Application No. PD2003U000061 from which this application claims priority are incorporated herein by reference.

What is claimed is:

1. A frame for casings, doors or windows, comprising: a base framework constituted by at least one laminated wood layer; a metallic skin for facing and outward protection of said framework; and adhesion means for connecting by adhesion said skin to said framework.

2. The frame of claim 1, wherein said frame is applied to a building, said metallic skin being located so as to adhere to a side of said framework that is directed toward the outside of the building to which said frame is applied.

3. The frame of claim 2, further comprising ventilation means for ventilating a wood portion of said framework that is proximate to said metallic skin.

4. The frame of claim 3, wherein said ventilation means are constituted by regions of said base framework uncovered by said metallic skin, said uncovered regions being adjacent to a peripheral end region of said metallic skin.

5. The frame of claim 4, wherein said ventilation means are constituted by a plurality of microperforations provided in a series arrangement on said metallic skin, cross-sectional dimensions of said microperforations being selected such as to hinder access of water and to be sufficient to ventilate wood that lies below said metallic skin.

6. The frame of claim 3, further comprising an exposed finishing veneer that adheres to a side of said framework that is directed toward the inside of the building to which said frame is applied.

7. The frame of claim 6, wherein said veneer is made of wood.

8. The frame of claim 3, wherein said metallic facing skin is made of materials or alloys selected from or based on aluminum, copper, brass, bronze, steel.

9. The frame of claim 8, wherein the thickness of said metallic facing skin is comprised between 0.1 mm and 0.35 mm.

10. The frame of claim 7, wherein said metallic facing skin has an external finish provided by a thermal bonding lacquer.

11. The frame of claim 8, wherein said metallic facing skin is made of a material selected from brass or copper, both in a soft or annealed physical state.

12. The frame of claim 8, wherein said metallic facing skin is made of an aluminum alloy of a 3005 or 8011 type, in a physical state being any of H14, H16, or H34.

13. The frame of claim 3, wherein said adhesion means comprises an adhesive.

14. The frame of claim 13, wherein said adhesive is of a reactive hot-melt type based on polyurethane with post-crosslinking.

15. The frame of claim 6, wherein said adhesion means comprise a thermal bonding film that is interposed between said metallic facing skin and said base framework.

16. The frame of claim 15, wherein said framework is constituted by at least two laminated wood layers that are mutually bonded by adhesive.

17. The frame of claim 6, shaped for a matchboard shutter, said metallic facing skin adhering to said outside, outward layer and to said inside, inward layer and having vertical grooves provided on said inward layer and said outward layer which are completely covered by said metallic skin.

18. The frame of claim 6, shaped for a Venetian-style shutter with slats, said metallic facing skin adhering to said outside, outward layer and to said inside, inward layer, said metallic skin being formed in two parts on each slat of said Venetian-style shutter frame, on an inner edge portion and outer edge portion of said base framework, said two parts being fixed respectively to said outward layer and said inward layer and having ends folded onto a head of each said slat and within a groove formed on a bottom of each said slat, said groove being suitable for coupling to the head of a corresponding adjacent slat.

19. The frame of claim 6, shaped for a door or front door, said metallic facing skin adhering to a layer that corresponds to an outward face of the door or front door, said exposed finishing veneer adhering to an inner face.

20. The frame of claim 6, shaped for a door or front door, said metallic facing skin adhering to a layer that corresponds to an outward face of said door or front door and to a layer that corresponds to an inward face.

21. The frame for door and window frames of claim 6, comprising fixing means for fixing to at least one portion of a perimetric edge of said base framework at least one metallic protective lamina.

22. The frame for doors or windows of claim 21, wherein said fixing means comprises at least one tab that protrudes at right angles from said metallic lamina and is inserted with interference within a corresponding slot that is formed in said at least one laminated wood layer.

23. The frame for doors and windows of claim 22, wherein said at least one tab is extended longitudinally and has a sawtooth contour on opposite sides.

24. The frame for doors and windows of claim 23, wherein said metallic lamina has arranged at the outer edge and at the inner edge that are formed by said perimetric edge of said base framework, a region that gradually decreases in thickness towards and up to a wider rim thereof at said outward edge and said inward edge, said framework having a bevel, said fixing means comprising silicone that is arranged within a retention cavity formed between said region and said bevel.

25. The frame for doors and windows of claim 24, wherein said wider rim has a substantially circular transverse cross-section.

26. The frame for doors and windows of claim 22, wherein said perimetric edge of said base framework, delimited by said outside, outward side and by said inside, inward side, is formed by a step-like portion for abutment during closure of the door or window onto a corresponding casing portion, said metallic protective lamina substantially following the shape of said step-like portion, said fixing means comprising two longitudinal tabs, each protruding at right angles from a respective one of two parallel surfaces, which follow said step-like portion, of said metallic lamina (517).

27. The frame for doors and windows of claim 22, wherein said metallic lamina is an extruded profiled element made of aluminum.
